(19) United States
(12) Patent Application Publication
(10) Pub. No.: US 2009/0319545 A1
(43) Pub. Date: Dec. 24, 2009

(54) Detailed data associating program, detailed data associating apparatus, and detailed data associating method

(76) Inventors: Yoshihiro Takagi, Kawasaki (JP); Masayuki Miura, Kawakami (JP); Hiroki Yamada, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/461,866

(22) Filed: Aug. 26, 2009

Related U.S. Application Data
(63) Continuation of application No. PCT/JP2007/053809, filed on Feb. 28, 2007.

(51) Int. Cl. G06F 17/30

(52) U.S. Cl. 707/100; 707/E17.009; 707/E17.045

(57) ABSTRACT

A method for associating detailed data is to aggregate the detailed data by using an aggregation key when detailed data generated in relation to a business is accumulated in a predetermined journal in a format that can identify an aggregation key and segments. The method includes storing the association between the segments as a business pattern; outputting the business pattern to an output unit so as to explicitly show the association between the segments, and associating an input business event name with each segment; outputting the business event name to the output unit and associating an input journal name with the business event name; and outputting the journal name to the output unit and associating an input rule with the journal name, the rule specifying which record in a journal identified by the journal name the detailed data identified by the business event name is.

### CROSS-REFERENCE TO RELATED APPLICATION

This application is a continuation of PCT international application Ser. No. PCT/JP2007/53809 filed on Feb. 28, 2007 which designates the United States, the entire contents of which are incorporated herein by reference.

### FIELD

The embodiments discussed herein are directed to a detailed data associating program, a detailed data associating apparatus, and a detailed data associating method.

### BACKGROUND

Conventionally, to adapt “detailed data” that is data having detailed content such as statements or vouchers and input to a backbone system or the like for a variety of business analysis, use of a data warehouse (DWH) is gaining attention. In general, analyses of the detailed data preformed by the data warehouse is achieved with the aid of the data warehouse that accumulates therein the detailed data, a data mart, which aggregates the detailed data accumulated in the data warehouse based on a desired analysis purpose and accumulates therein the aggregation result, a front end application, which analyzes the aggregation result accumulated in the data mart, or the like.

An approach that aggregates the detailed data is specifically explained as an example. For example, Japanese Patent No. 3476349 discloses a data processing apparatus that aggregates the detailed data including common items (e.g., “sales period”, “product name”, “sales region”, or “sales data”) based on hierarchy-structured information on each item (e.g., “computer” or “personal computer” related to “product name”, or “nationwide”, “Kanto area”, “Tokyo”, or the like related to “sales region”) on an element basis that corresponds to the analysis purpose (e.g., “Tokyo”).

### SUMMARY

According to an aspect of an embodiment of the present invention, a detailed data associating apparatus for creating an association between pieces of detailed data to aggregate the detailed data by using an aggregation key when the detailed data generated in relation to a business is accumulated in a predetermined journal in a format that identifies the aggregation key used to aggregate the detailed data and segments used to manage the detailed data in the course of business. The detailed data associating apparatus includes a business pattern storing unit that stores the association between the segments as a business pattern corresponding to a primary aggregation key that is a broader concept of the aggregation key; a business event name creating unit that outputs the business pattern stored in the business pattern storing unit, to a predetermined output unit so as to explicitly show the association between the segments, receives in a predetermined input unit a business event name input that identifies the segments belonging to each aggregation key, and creates the association between the received business event name and each segment; a journal name creating unit that outputs the business event name received by the business event name creating unit to a predetermined output unit, receives a journal name input identifying a journal that accumulates therein the detailed data identified by the business event name in a predetermined input unit, and associates the received journal name with the business event name; and a rule creating unit that outputs the journal name received by the journal name creating unit to a predetermined output unit, receives a rule in a predetermined input unit, the rule specifying which record in the journal identified by the journal name the detailed data identified by the business event name received by the business event name creating unit is, and associates the received rule with the journal name.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic for explaining an overview and features of a detailed data associating apparatus according to a first embodiment;

FIG. 2 is a block diagram of the detailed data associating apparatus according to the first embodiment;

FIG. 3 is a schematic for explaining a business pattern storage unit;

FIG. 4 is a schematic for explaining an association storage unit;

FIGS. 5A to 5D are schematics for explaining a process flow performed by the detailed data associating apparatus;

FIGS. 6A to 6D are schematics for explaining a process flow performed by the detailed data associating apparatus;

FIGS. 7A to 7D are schematics for explaining a process flow performed by the detailed data associating apparatus;

FIGS. 8A to 8D are schematics for explaining a process flow performed by the detailed data associating apparatus;

FIGS. 9A to 9D are schematics for explaining a process flow performed by the detailed data associating apparatus;

FIGS. 10A to 10D are schematics for explaining a process flow performed by the detailed data associating apparatus;

FIGS. 11A to 11D are schematics for explaining a process flow performed by the detailed data associating apparatus;

FIGS. 12A to 12D are schematics for explaining a process flow performed by the detailed data associating apparatus;

FIGS. 13A to 13D are schematics for explaining a process flow performed by the detailed data associating apparatus;

FIGS. 14A to 14D are schematics for explaining a process flow performed by the detailed data associating apparatus;

FIGS. 15A to 15D are schematics for explaining a process flow performed by the detailed data associating apparatus;

FIGS. 16A to 16D are schematics for explaining a process flow performed by the detailed data associating apparatus;

FIG. 17 is a schematic for explaining an exemplary output from the detailed data associating apparatus;

FIG. 18 is a schematic for explaining an exemplary output from the detailed data associating apparatus;

FIG. 19 is a schematic for explaining an exemplary output from the detailed data associating apparatus;

FIG. 20 is a flowchart of a processing procedure of the detailed data associating apparatus according to the first embodiment;

FIG. 21 is a flowchart of a processing procedure of a shared output unit;

FIG. 22 is a schematic for explaining an exemplary output from the detailed data associating apparatus; and

FIG. 23 is a schematic for explaining a computer that executes a detailed data associating program.

### DESCRIPTION OF EMBODIMENTS

Embodiments of a detailed data associating program, a detailed data associating apparatus, and a detailed data associating method according to the present invention are described in detail with reference to the accompanying drawings. Description will be given in the order as follows: terms as used in the embodiments, an overview and features of the detailed data associating apparatus according to a first embodiment, configurations and a processing procedure of the detailed data associating apparatus according to the first embodiment, and effects of the first embodiment. Subsequently, another embodiment will be explained.

First, major terms as used below in the embodiments are explained. A term “detailed data” means data having detailed content such as statements or vouchers and including items such as a “recording identifying segment”, an “account”, “transaction date”, “voucher No.”, “money amount”, and “recorded date”. The term “detailed data” is daily produced in relation to “business” and accumulated in a database called a “journal” on daily basis.

As can be seen by taking one “business” as an example, a wide variety of “detailed data” is produced for one “business” in relation to a business negotiation, order intake, sales, or cost experienced in the “business” or the like. Therefore, when the “detailed data” is accumulated in the “journal,” a segment is typically set that is used to manage the “detailed data” in the “business” and a format is applied that can identify which “segment” the “detailed data” belongs to.

For example, when the “business” is managed using the segment “budget” and the corresponding segments “plan”, “prospects”, and “actual achievement”, the “detailed data” is accumulated in the “journal” in a format that can identify whether the “detailed data” belongs to the “budget”, the “plan”, the “prospects”, or the “actual achievement”. In other words, the “detailed data” is accumulated in the “journal” in a format structure forcing the “detailed data” to include an item that identifies which “segment”, namely which one of the “budget”, the “plan”, and the “actual achievement” the “detailed data” belongs to or the like. The “recording identifying segment” is an example of such “segment”. For example, the “detailed data” having the “budget” as the “recording identifying segment” is identified as the “detailed data” in the “budget” segment in the “business”, the “detailed data” having the “business negotiation” as the “recording identifying segment” is identified as the “detailed data” in the “plan” segment in the “business”, the “detailed data” having the “order intake” as the “recording identifying segment” is identified as the “detailed data” in the “prospects” segment in the “business”, the “detailed data” having the “sales” as the “recording identifying segment” is identified as the “detailed data” in the “actual achievement” segment in the “business”, and so on.

However, simply accumulating the “detailed data” in the “journal” does not have any sense. The “detailed data” has its use when aggregated using any “aggregation key” and then analyzed this aggregation result. Therefore, when the “detailed data” is accumulated in the “journal”, an “aggregation key” is typically set that is used to aggregate the “detailed data” and a format is applied that can identify which “aggregation key” the “detailed data” belongs to. For example, when the “detailed data” is aggregated using the “aggregation key” such as a “net sales”, a “cost of sales”, or a “selling expense”, the “detailed data” is accumulated in the “journal” in a format or the like that can identify whether the “detailed data” belongs to the “net sales”, the “cost of sales”, or the “selling expense”. In other words, the “detailed data” is accumulated in the “journal” in a format structure forcing the “detailed data” to include an item that identifies which “aggregation key” such as the “net sales”, the “cost of sales”, or the “selling expense” the “detailed data” belongs to. The “account list” is an example of such “aggregation key”.

Because the “segment” and the “aggregation key” identify the “detailed data” from different point of view as described above, each piece of the “detailed data” produced in relation to one “business” is typically identified by the different “aggregation key” even if each piece has the same “segment”. For example, some pieces of the “detailed data” in the “sales” segment in the “business” are identified by the “net sales” aggregation key and others are identified by the “cost of sales” aggregation key. Because the association between pieces of the “detailed data” is complicated in this way, it has been difficult to develop a system intended to aggregate the “detailed data”. Therefore, it is important how the detailed data associating apparatus according to the present invention enables the system intended to aggregate the “detailed data” to be readily developed.

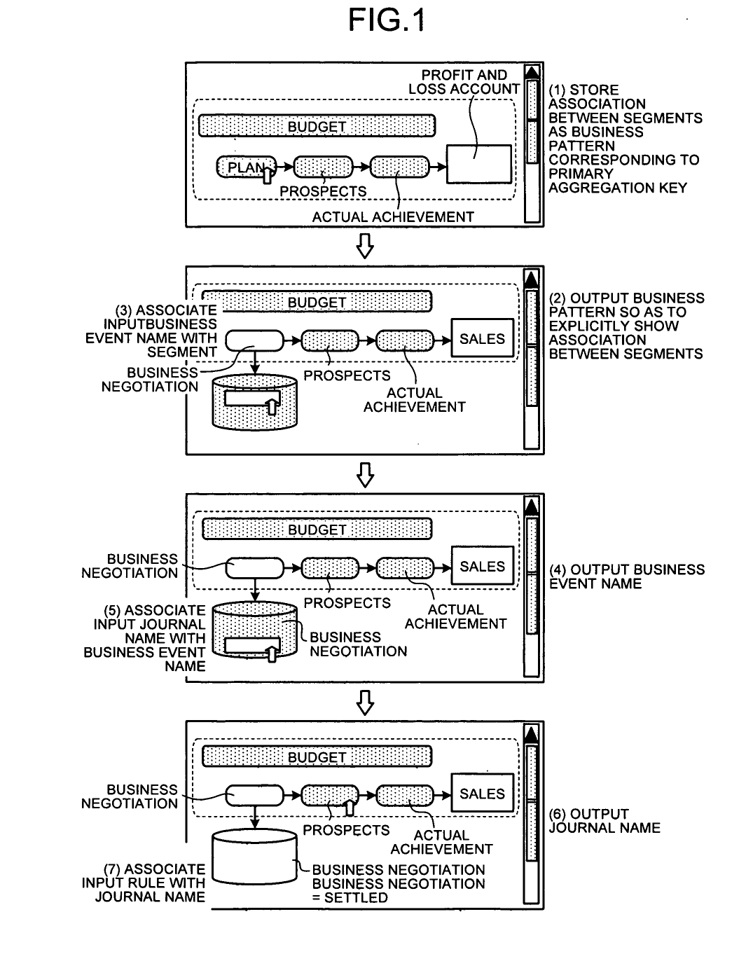

Referring next to FIG. 1, the overview and the features of the detailed data associating apparatus according to the first embodiment are explained. FIG. 1 is a schematic for explaining the overview and the features of the detailed data associating apparatus according to the first embodiment. Note that, in FIG. 1, exemplary four screen images output to an output unit (such as a display) of the detailed data associating apparatus are shown in a chronological order.

As described above, the detailed data associating apparatus according to the first embodiment associates the detailed data such that the detailed data are aggregated by the aggregation key when the detailed data produced in relation to the business is accumulated in the predetermined journal in a format that can identify the aggregation key used to aggregate the detailed data and the segment used to manage the detailed data in the business. The main feature of the detailed data associating apparatus according to the first embodiment is to enable the system intended to aggregate the detailed data to be readily developed.

Main feature is briefly explained. The detailed data associating apparatus according to the first embodiment stores therein the association between the segments as a business pattern corresponding to a primary aggregation key, which is a broader concept of the aggregation key. For example, the detailed data associating apparatus stores, as the association between the segments used to manage the detailed data in the business, the “budget” and the corresponding business pattern including the “plan”, the “prospects”, and the “actual achievement” in association with the primary aggregating key “profit and loss account”, in advance in a storage unit (see FIG. 1 (1)). Note that, in FIG. 1 (1), the screen image, which is the business pattern stored in advance in the storage unit, output from the detailed data associating apparatus to the output unit is depicted.

With such a configuration, the detailed data associating apparatus outputs the business pattern stored in advance in the storage unit to the output unit to explicitly show the association between the segments (see FIG. 1 (2)). The detailed data associating apparatus also receives, in an input unit, a business event name input that identifies segments belonging to each aggregation key and associates the input business event name with the segment (see FIG. 1 (3)).

Referring to FIGS. 1 (2) and (3) as an example, the detailed data associating apparatus explicitly shows the association between the segments, for example, a business flow going from the “plan” to the “prospects”, and then from the “prospects” to the “actual achievement” is shown with arrows and the “budget” is shown with a big icon. Note that, according to the first embodiment, the detailed data associating apparatus outputs the business pattern to the output unit, explicitly showing the association with the primary aggregation key “profit and loss account”. The detailed data associating apparatus receives, in the input unit, the “business negotiation” input as the business event name input that identifies the segment (“plan”) belonging to each aggregation key and associates the input “business negotiation” with the segment “plan”.

The detailed data associating apparatus outputs the input business event name to the output unit (see FIG. 1 (4)). The detailed data associating apparatus receives the journal name input that identifies the journal that accumulates therein the detailed data identified by the business event name and associates the input journal name with the business event name (see FIG. 1 (5)).

Referring to FIGS. 1 (4) and (5) as an example, the detailed data associating apparatus outputs an icon “plan” replaced with the input business event name “business negotiation”. The detailed data associating apparatus receives, in the input unit, the “business negotiation” input as the journal name input identifying the journal and associates the input “business negotiation” with the business event name “business negotiation”. FIG. 1 (4) as an example, to show that the “business negotiation” is associated with the segment “plan”, the “plan” icon with half-tone dot meshing is turned to the icon without half-tone dot meshing upon input of the “business negotiation”.

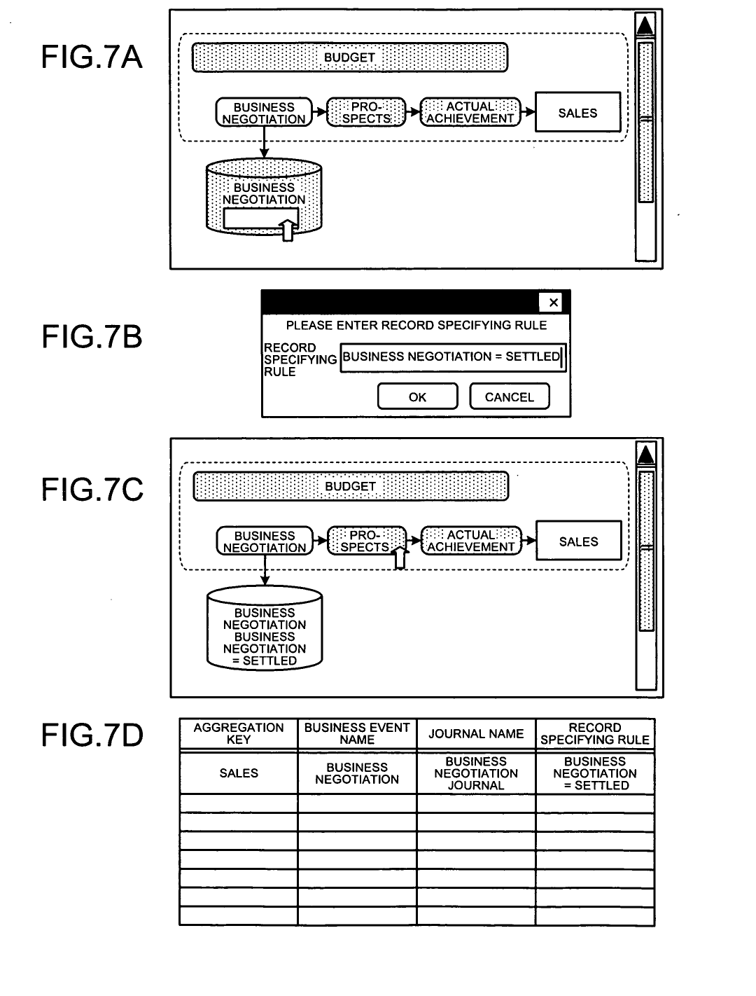

The detailed data associating apparatus outputs the input journal name to the output unit (see FIG. 1 (6)). The detailed data associating apparatus receives, in the input unit, a rule (hereinafter, “record specifying rule”) input that specifies which record in the journal identified by the journal name the detailed data identified by the input business event name is and associates the input record specifying rule with the journal name (see FIG. 7 (7)).

Referring to FIGS. 1 (6) and (7) as an example, the detailed data associating apparatus outputs the input journal name “business negotiation” in a database icon having association with a “business negotiation” icon. The detailed data associating apparatus receives, in the input unit, “business negotiation=settled” input as the record specifying rule input that specifies which record in the journal identified by the journal name “business negotiation” the detailed data is and associates the input “business negotiation=settled” with the journal name “business negotiation”.

In this way, the detailed data associating apparatus according to the first embodiment enables the system intended to aggregate the detailed data to be readily developed.

Specifically, for example, a user of the system or the like is only required to understand the business pattern as knowledge in the course of his/her work related to the detailed data aggregation and to input the associations between the business pattern and the business event name, the journal name, and the record specifying rule while viewing the business pattern output on the output unit such as a display, a system intended to aggregate the detailed data can developed.

Note that, according to the first embodiment, as described above, an example in which the detailed data associating apparatus stores therein the business pattern including the “budget” and the corresponding “plan”, “prospects”, and “actual achievement” is explained. However, this is only an example and any business pattern suitable for an operation form may be stored in the detailed data associating apparatus. Similarly, in the first embodiment, as the business event names, terms such as the “business negotiation”, the “order intake”, “sales”, or the “paid cost” are used. However, these terms are only an example and any business event name suitable for an operation may be used. In addition, expressions used in the first embodiment in terms of the journal name, the record specifying rule, and screen image arrangement are only an example and any journal name, record specification rule, and screen image arrangement suitable for operation may be used.

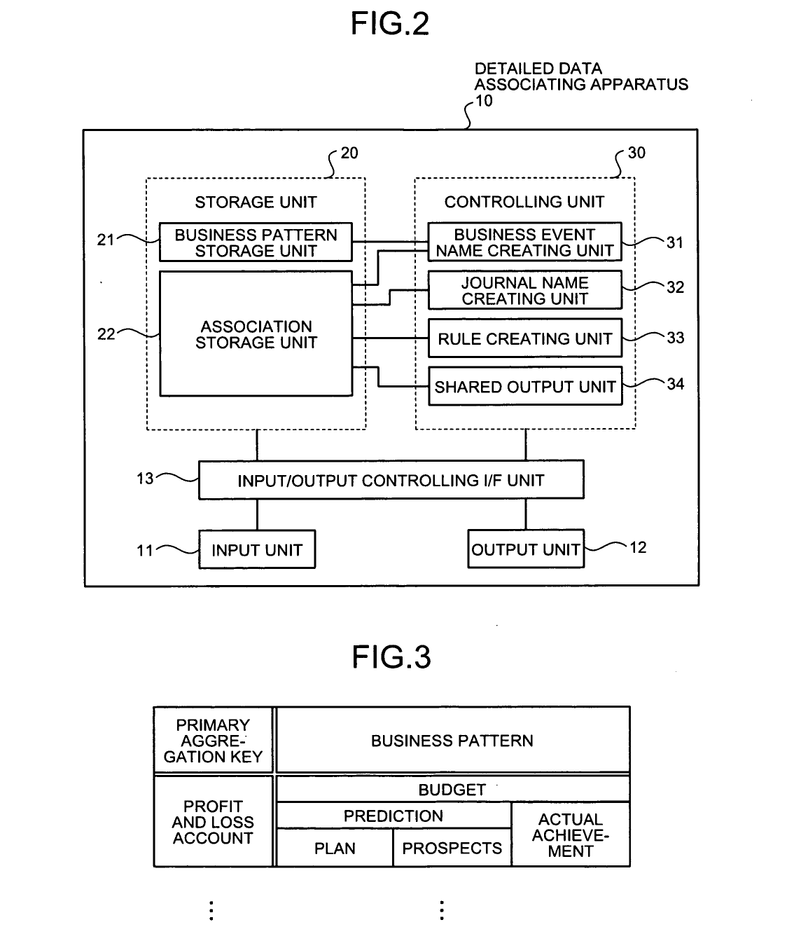

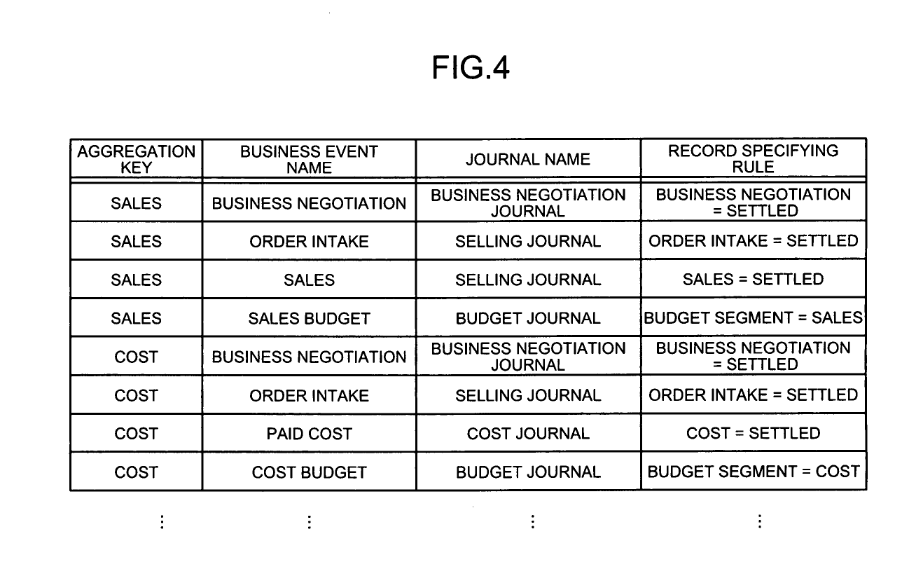

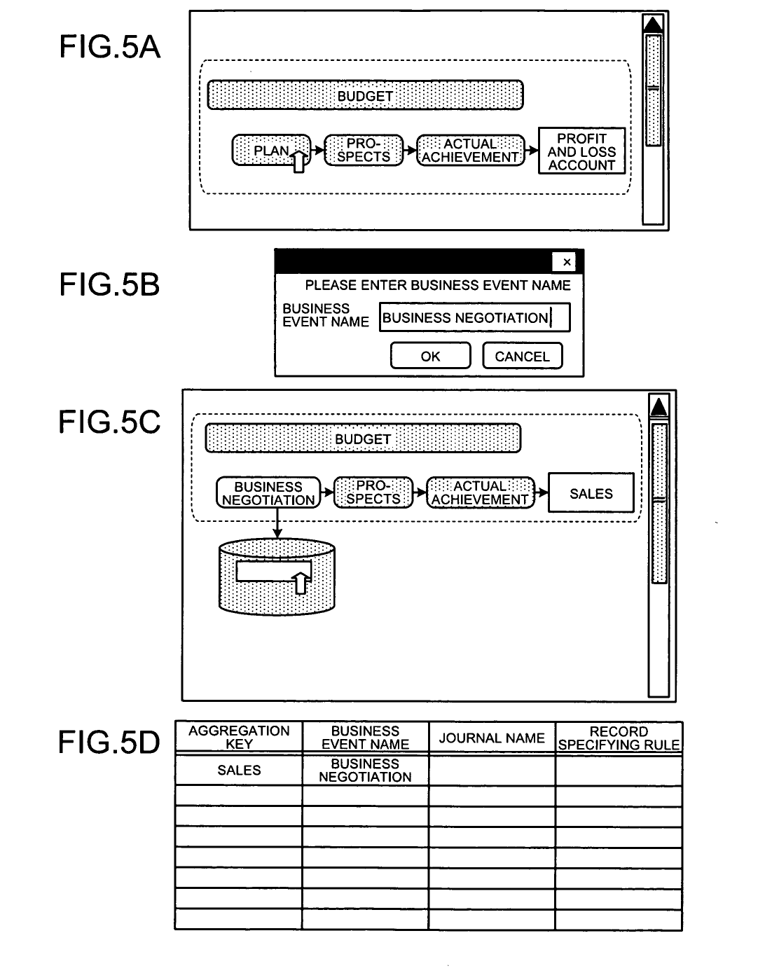

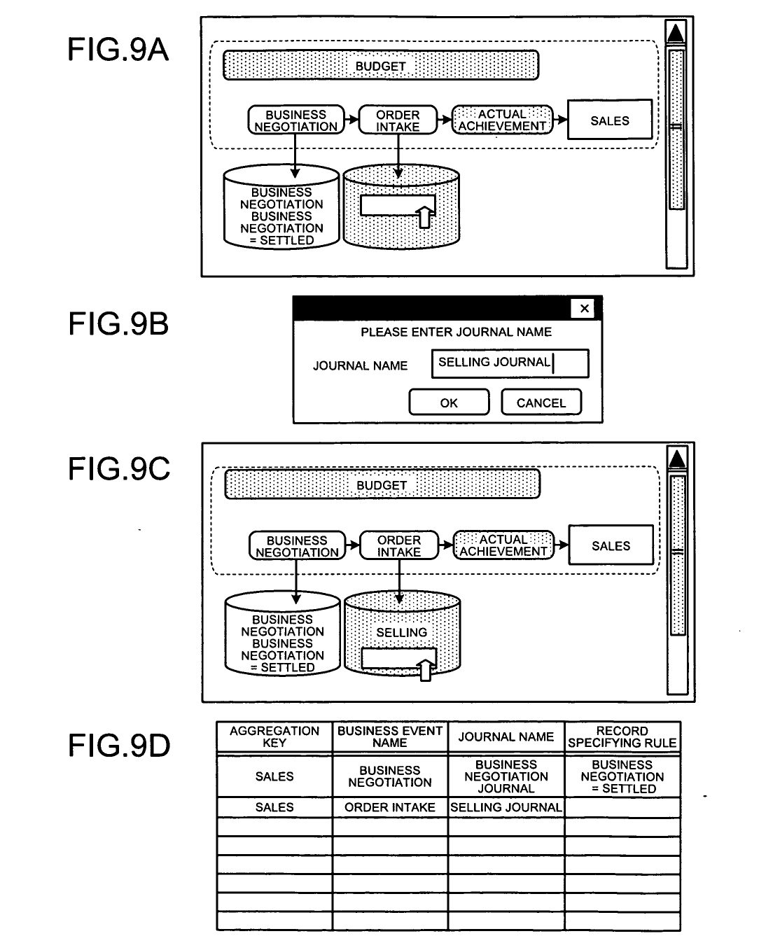

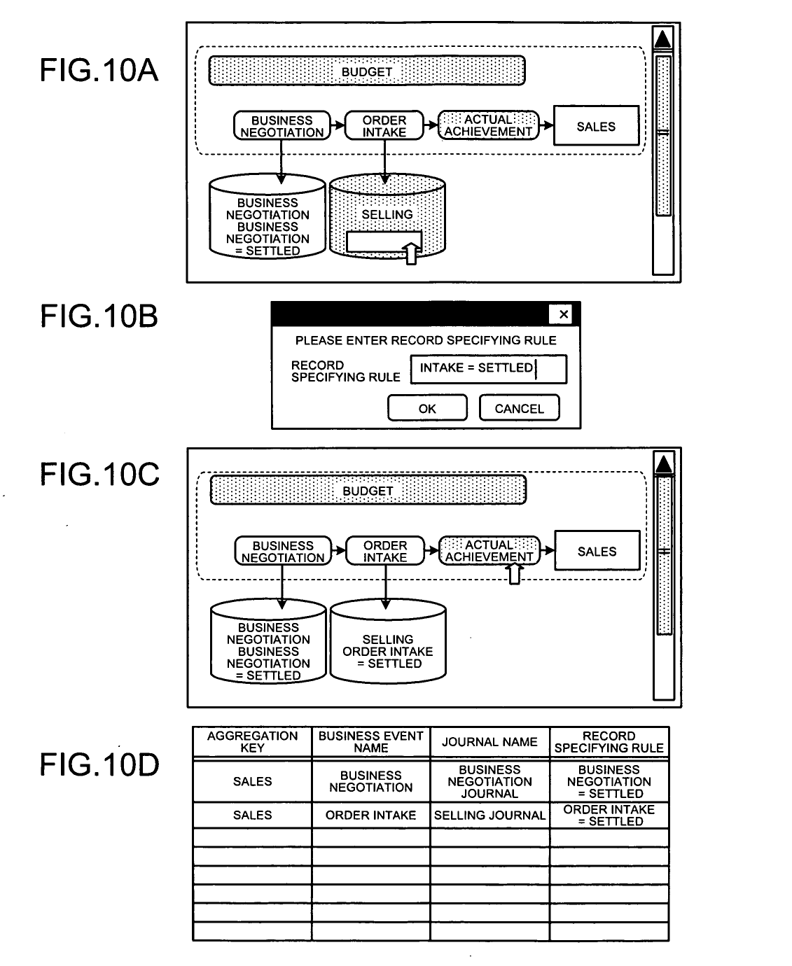

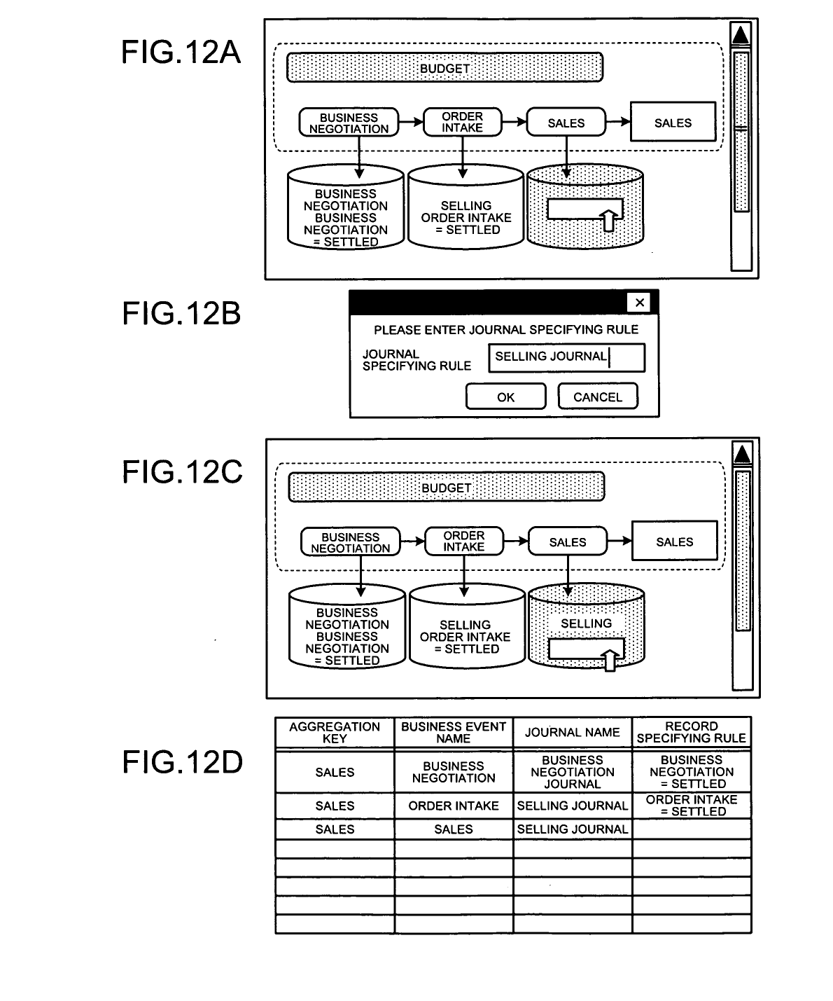

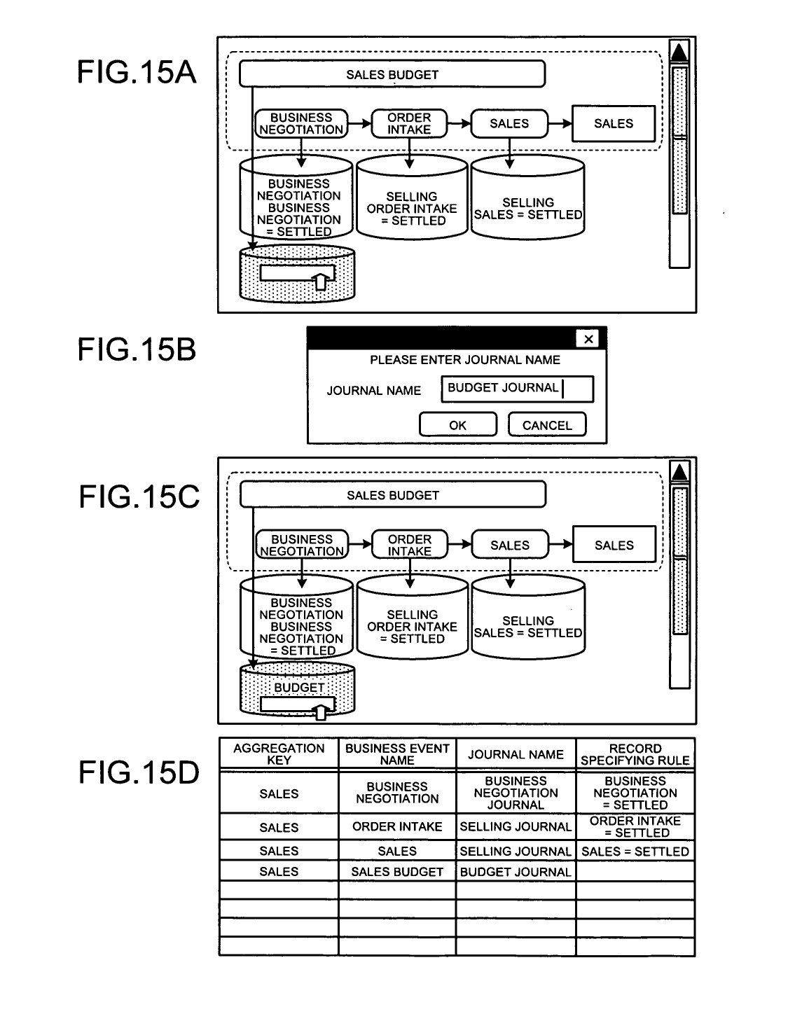

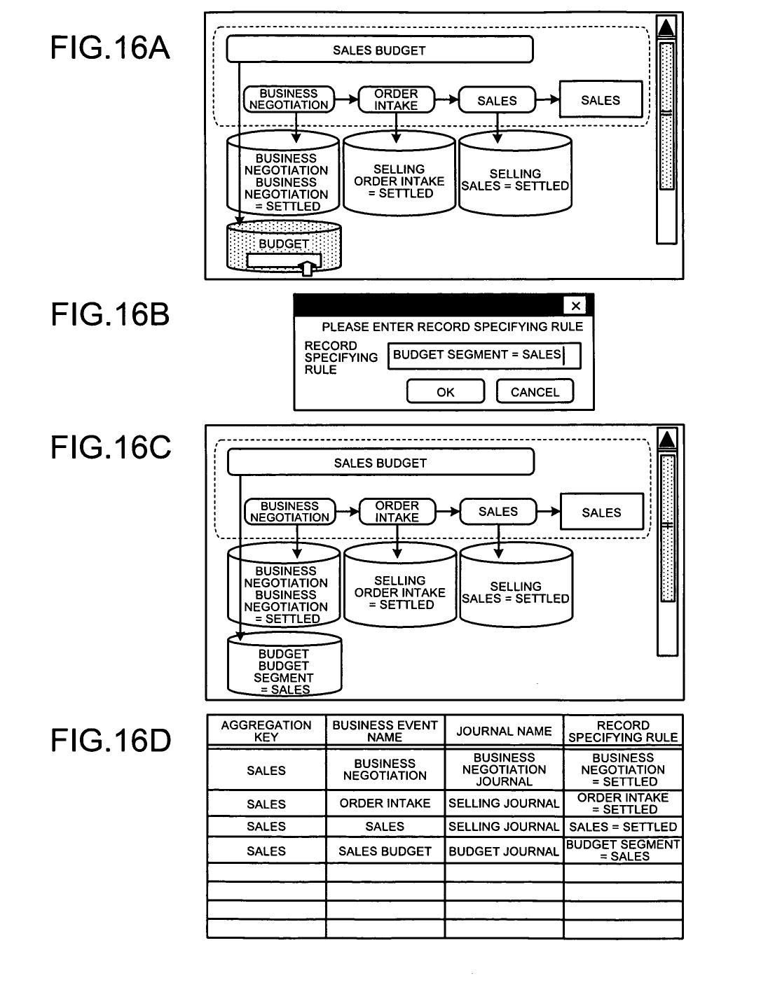

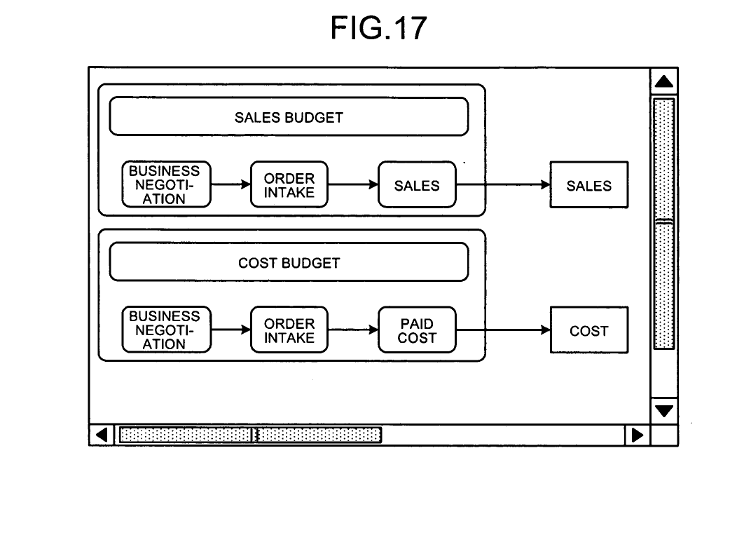

Referring to FIGS. 2 to 19, the detailed data associating apparatus according to the first embodiment is explained. FIG. 2 is a block diagram of the detailed data associating apparatus according to the first embodiment. FIG. 3 is a schematic for explaining a business pattern storage unit. FIG. 4 is a schematic for explaining an association storage unit. FIGS. 5A to 16D are schematics for explaining processing flows performed by the detailed data associating apparatus. FIGS. 17 to 19 are schematics for explaining exemplary output from the detailed data associating apparatus.

As depicted in FIG. 2, a detailed data associating apparatus 10 according to the first embodiment includes an input unit 11, an output unit 12, an input/output controlling interface (I/F) unit 13, a storage unit 20, and a controlling unit 30.

The input unit 11 receives data used for various processing performed by the controlling unit 30 or operation instructions for various processing via a keyboard, a mouse, a storage medium, communications, or the like. In particular, the input unit 11 receives such as the business event name input via a business event name creating unit 31 described below, the journal name input via a journal name creating unit 32 described below, the record specifying rule input via a rule creating unit 33 described below, an output instruction to output by a shared output unit 34 described below.

The output unit 12 outputs results of various processing performed by the controlling unit 30 or operation instructions for various processing to a display, a printer, or the like. In particular, the output unit 12 outputs to the display screen images output from the business event name creating unit 31, the journal name creating unit 32, the rule creating unit 33 the shared output unit 34, or the like, all of which will be described below.

The input/output controlling I/F unit 13 controls data transfer between the input unit 11 and the storage unit 20, and the output unit 12 and the controlling unit 30.

The storage unit 20 is a storage unit that stores therein data used for various processing performed by the controlling unit 30. Particularly, components that are closely related to the present invention include, as depicted in FIG. 2, a business pattern storage unit 21 and an association storage unit 22. Note that, the business pattern storage unit 21 corresponds to a term “business pattern storing procedure” found in claims.

The business pattern storage unit 21 stores therein the association between the segments as the business pattern corresponding to the primary aggregation key, which is a broader concept of the aggregation key. In particular, the business pattern storage unit 21 stores therein the business pattern in association with the primary aggregation key. The stored business pattern is used for processing performed by the business event name creating unit 31 described below.

For example, the business pattern storage unit 21 stores therein a business pattern as depicted in FIG. 3. In particular, the business pattern storage unit 21 stores therein in advance, as the association between the segments used to manage the detailed data in the business, the business pattern including the “budget” and the corresponding “plan”, “prospects”, and “actual achievement” in association with the primary aggregation key “profit and loss accounting”.

Note that, according to the first embodiment, an example that the business pattern storage unit 21 stores therein the business pattern including the “budget” and the corresponding “plan”, “prospects”, and “actual achievement” is explained. Note that, however, this is only an example and any business pattern suitable for the operation form may be stored therein. In the first embodiment, an example that the business pattern storage unit 21 stores one business pattern therein is explained. However, the present invention is not limited so and can be equally applied to a case storing a plurality of business patterns in the business pattern storage unit 21.

The association storage unit 22 stores the created association therein. In particular, the association storage unit 22 stores therein the association between the business event name created in the business event name creating unit 31 described below and the segment, the association between the journal name created in the journal name creating unit 32 described below and the business event name, and the association between the record specifying rule created in the rule creating unit 33 described below and the journal name. The stored association is used to output by the shared output unit 34 described below, to associate actual detailed data according to the association, or to do other processing.

For example, the association storage unit 22 stores therein the associations (a condition table) as depicted in FIG. 4. In particular, the association storage unit 22 stores therein the aggregation key, the business event name, the journal name, and the record specifying rule in relation to each other. For example, the detailed data identified by the aggregation key “sales” and identified by the business event name “business negotiation” is a record specified by the record specifying rule “business negotiation=settled” accumulated in the journal identified by the journal name “business negotiation journal”.

Note that, the association storage unit 22 sequentially stores therein the associations as depicted in FIG. 4, following to processing performed by the business event name creating unit 31, the journal name creating unit 32, and the rule creating unit 33, all of which will be described below. An example in FIG. 4 represents that a detailed data, identified by the aggregation key “cost” and identified by the business event name “cost budget”, is a record accumulated in the journal identified by the journal name “budget journal” and specified by the record specifying rule “budget segment=cost”, and that the above association has just been created. These associations are not stored in the association storage unit 22 at once but stored therein sequentially as will be described in detail below.

According to the first embodiment, an approach that the association storage unit 22 stores therein the aggregation keys, the business event names, the journal names, and the record specifying rules in relation to each other is explained. However, the present invention is not limited so and any approach using any concrete storage structure can be used as long as the association between the business event name and the segment, the association between the journal name and the business event name, and the association between the record specifying rule and the journal name are stored therein.

The controlling unit 30 is a controlling unit that controls the detailed data associating apparatus 10 to perform various processing. Components, particularly closely related to the present invention, are, as depicted in FIG. 2, the business event name creating unit 31, the journal name creating unit 32, the rule creating unit 33, and the shared output unit 34. Note that, the business event name creating unit 31 corresponds to a term “business event name creating procedure” found in claims. The journal name creating unit 32 corresponds to a term “journal name creating procedure” found in claims. The rule creating unit 33 corresponds to a term “rule creating procedure” found in claims. The shared output unit 34 corresponds to a term “shared output procedure” found in claims.

The business event name creating unit 31 associates the business event name with the segment. In particular, the business event name creating unit 31 outputs the business pattern stored in the business pattern storage unit 21 to the output unit 12 so that the association between the segments is explicitly shown. The business event name creating unit 31 receives, in the input unit 11, the business event name input identifying the segments belonging to each aggregation key, associates the input business event name with the segments, and stores the created association in the association storage unit 22.

According to the first embodiment, when the business event name creating unit 31 outputs the business pattern so that the association between the segments is explicitly shown, the business event name creating unit 31 also outputs so as to explicitly show the association with the primary aggregation key or the aggregation key.

The journal name creating unit 32 associates the journal name with the business event name. In particular, the journal name creating unit 32 outputs the business event name (that is stored in the association storage unit 22) received by the business event name creating unit 31 to the output unit 12. The journal name creating unit 32 receives, in the input unit 11, the input portion of the journal name identifying the journal that accumulates therein the detailed data identified by the business event name, associates the input journal name with the business event name, and stores the created association in the association storage unit 22.

The rule creating unit 33 associates the journal name with the record specifying rule. In particular, the rule creating unit 33 outputs the journal name (that is stored in the association storage unit 22) received from the journal name creating unit 32 to the output unit 12. The rule creating unit 33 receives in the input unit 11 the record specifying rule input that specifies which record in the journal identified by the journal name the detailed data identified by the business event name (that is stored in the association storage unit 22) received by the business event name creating unit 31 is, associates the input record specifying rule with the journal name, and stores the created association in the association storage unit 22.

The business event name creating unit 31, the journal name creating unit 32, and the rule creating unit 33 have been explained. Referring to FIGS. 5A to 16D, using the aggregation key “sales” as an example, processing flow performed by each units and output images are explained in detail. Note that, each of FIGS. 5A to 16D corresponds to each of sections (A) to (D): (A) is a screen image showing information output required for processing explained in the figure; (B) is a view of information for receiving an input with respect to the screen image (A); (C) is a view of a screen image after the information input is received on section (B); and (D) is a view of the association stored in the association storage unit 22 upon completing a sequence of the processing explained in the figure.

However, the screen images, information for receiving an input, and the processing flows depicted in FIGS. 5A to 16D are only an example. The present invention can be equally applied in any cases such as when the screen images have different arrangement, the information for receiving an input is not output, or the processing flows differ, or in other cases.

FIG. 5A is a view of the screen image output by the business event name creating unit 31 on the display that illustrates the business pattern stored in the business pattern storage unit 21 with the association between the segments explicitly shown. The business event name creating unit 31 so as to explicitly show the association between the segments, for example, the business flows going from the “plan” to the “prospects”, and then from the “prospects” to the “actual achievement” are shown with arrows and the “budget” is shown with the big icon or the like to show its correspondence to these segments. Note that, according to the first embodiment, the business event name creating unit 31 outputs the business pattern on the display so that the association with the primary aggregation key “profit and loss account” is also explicitly shown. In addition, according to the first embodiment, icons are shown with half-tone dot meshing or the like to explicitly show that the icons have not yet been associated with anything, icons are shown without half-tone dot meshing or the like to explicitly show that the icons have already been associated with something. Further, according to the first embodiment, one of the icons that is under the processing is indicated by an arrow or the like.

FIG. 5B is a view of the screen image that is information that the business event name creating unit 31 outputs on the display. The information is for receiving the business event name input identifying the segments belonging to each aggregation key via the input unit 11 such as a keyboard. The business event name creating unit 31 outputs, for example, a text message “Please enter a business event name.” prompting input of the business event name, a box that receives the business event name input, or the like. In FIG. 5B, the screen image has already received “business negotiation” as the business event name (a vertical bar on the right side of the words “business negotiation” refers current cursor location).

FIG. 5C is a view of the screen image on the display that illustrates the status of the association that the business event name creating unit 31 created between the input business event name and the segment. For example, the business event name creating unit 31 replaces a word “plan” with the input business event name “business negotiation” and outputs to the icon. To show that the “business negotiation” is associated with the segment “plan”, the “plan” icon with half-tone dot meshing is turned to the icon without half-tone dot meshing upon receiving the “business negotiation”.

FIG. 5D is a view of the association between the business event name and the segment created by the business event name creating unit 31 and stored in the association storage unit 22. The association storage unit 22 stores therein the aggregation key “sales” in association with the business event name “business negotiation”.

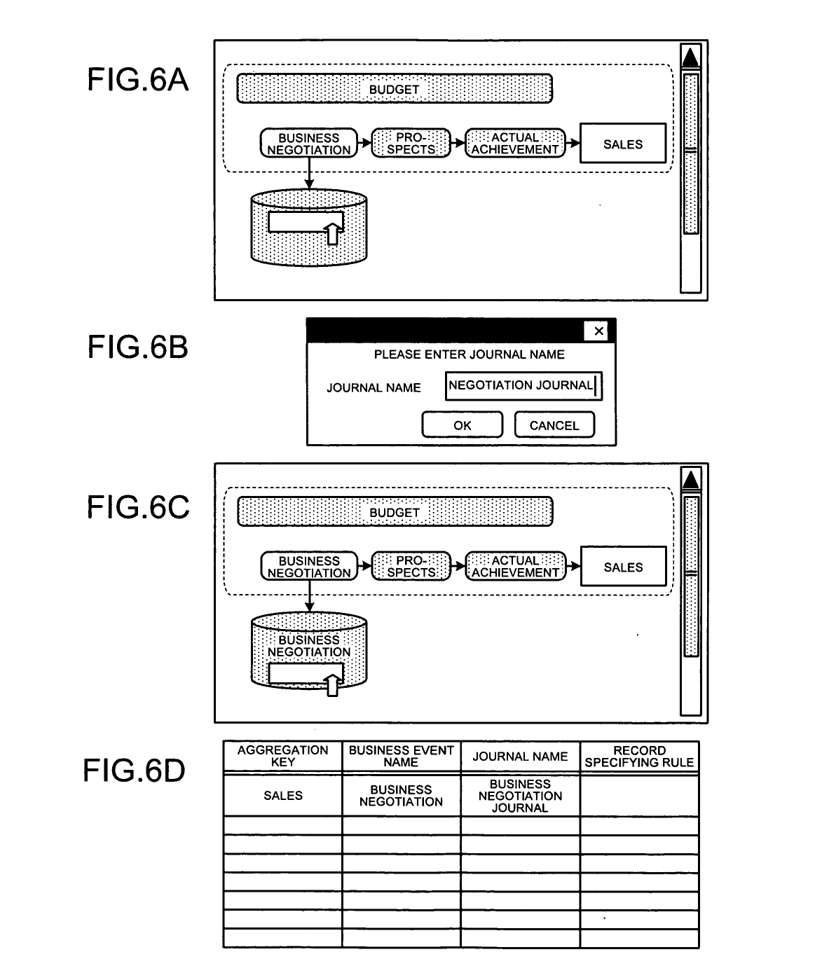

FIG. 6A is a view of the screen image output by the journal name creating unit 32 on the display that illustrates the business event name received by the business event name creating unit 31. For example, the journal name creating unit 32 replaces and outputs the word “plan” to the icon with the input business event name “business negotiation”. To show that the “business negotiation” is associated with the segment “plan”, the “plan” icon with half-tone dot meshing is turned to the icon without half-tone dot meshing upon inputting the “business negotiation”. Note that, according to the first embodiment, the screen image depicted in FIG. 6A is the same as that depicted in FIG. 5C (the screen image may be output by either of the business event name creating unit 31 or the journal name creating unit 32).

FIG. 6B is a view of the screen image that is information that the journal name creating unit 32 outputs on the display. The information is for receiving the journal name input identifying the journal that accumulates therein the detailed data that identified by the business event name via the input unit 11 such as a keyboard. The journal name creating unit 32 outputs, for example, a text message “Please enter a journal name” prompting input of the journal name, a box that receives the journal name input, or the like. In FIG. 6B, the screen image has already received the “business negotiation journal” as the journal name.

FIG. 6C is a view of the screen image on the display that illustrates the status of the association that the journal name creating unit 32 created between the input journal name and the business event. The journal name creating unit 32 outputs the input journal name “business negotiation journal” (that is depicted as the “business negotiation” in FIG. 6C) to the database icon associated with the “business negotiation” icon.

FIG. 6D is a view of the association between the journal name and the business event name created by the journal name creating unit 32 and stored in the association storage unit 22. The association storage unit 22 stores therein the aggregation key “sales”, the business event name “business negotiation”, and further the journal name “business negotiation journal” in relation to each other.

FIG. 7A is a view of the screen image output by the rule creating unit 33 on the display that illustrates the journal name received from the journal name creating unit 32. For example, the rule creating unit 33 outputs the input journal name “business negotiation journal” (that is depicted as the “business negotiation” in FIG. 7A) to the database icon associated with the “business negotiation” icon. Note that, according to the first embodiment, the screen image depicted in FIG. 7A is the same as that depicted in FIG. 6C (the screen image may be output by either of the journal name creating unit 32 or the rule creating unit 33).

FIG. 7B is a view of the screen image that is information that the rule creating unit 33 outputs on the display. The information is for receiving the input of the record specifying rule specifying which detailed data identified by the business name event is the record of journal that is identified by the journal name. The rule creating unit 33 outputs, for example, a text message “Please enter a record specifying rule” prompting input of the record specifying rule, a box that receives the record specifying rule input, or the like. In FIG. 7B, the screen image has already received the “business negotiation settled” as the record specifying rule.

FIG. 7C is a view of the screen image on the display that illustrates status of the association that the rule creating unit 33 created between the input record specifying rule and the journal name. The rule creating unit 33 outputs the record specifying rule “business negotiation=settled” to the database icon associated with the “business negotiation” icon with the “business negotiation” icon.

FIG. 7D is a view of the association between the record specifying rule and the journal name created by the rule creating unit 33 and stored in the association storage unit 22. The association storage unit 22 stores therein the aggregation key “sales”, the business event name “business negotiation”, the journal name “business negotiation journal”, and further the record specifying rule “business negotiation=settled” in relation to each other.

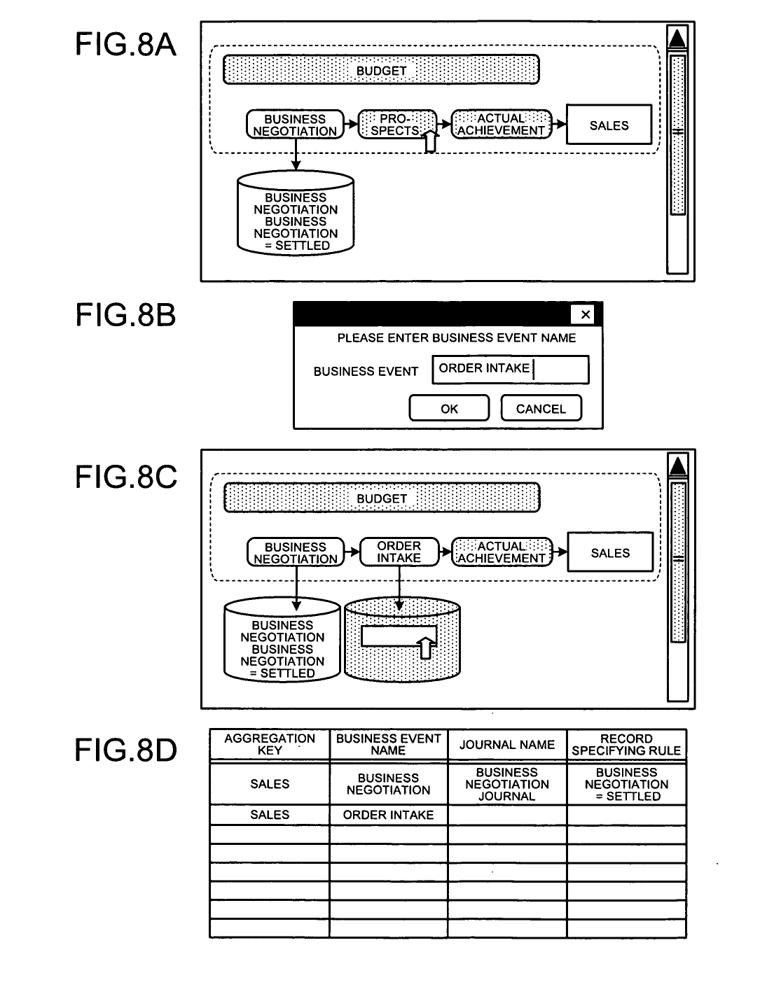

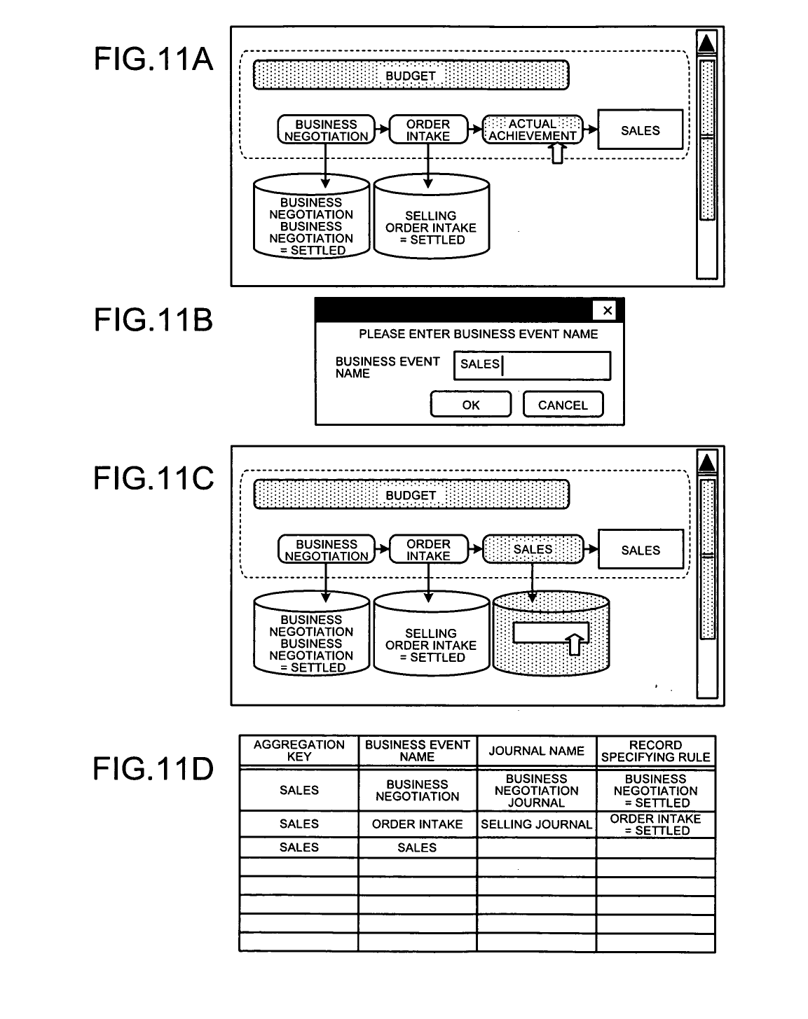

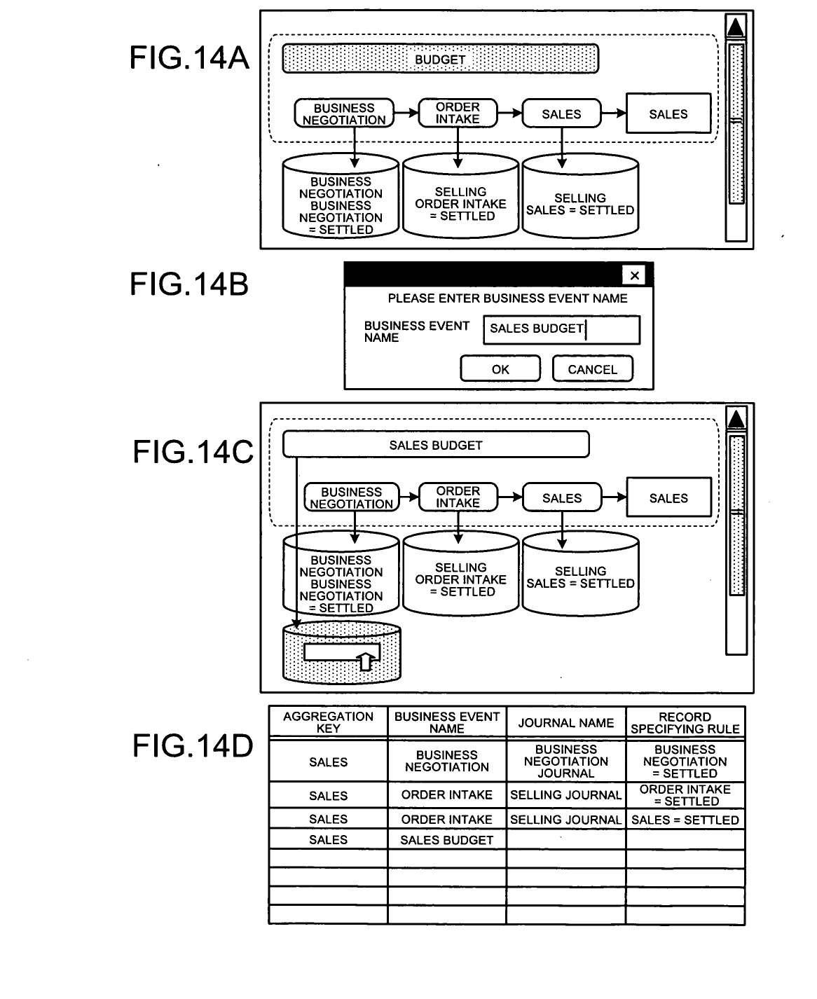

In FIGS. 5A to 7D, the business event name creating unit 31, the journal name creating unit 32, and the rule creating unit 33 complete to associate the detailed data identified by the aggregation key “sales” and the business event name “business negotiation”. FIGS. 8A to 10D depict how the business event name creating unit 31, the journal name creating unit 32, and the rule creating unit 33 associate the detailed data identified by the aggregation key “sales” and the business event name “order intake”, similar to FIGS. 5A to 7D. FIGS. 11A to 13D depict how the business event name creating unit 31, the journal name creating unit 32, and the rule creating unit 33 associate the detailed data identified by the aggregation key “sales” and the business event name “sales”, similar to FIGS. 5A to 7D. FIGS. 14A to 16D depict how the business event name creating unit 31, the journal name creating unit 32, and the rule creating unit 33 associate the detailed data identified by the aggregation key “sales” and the business event name “budget”, similar to FIGS. 5A to 7D.

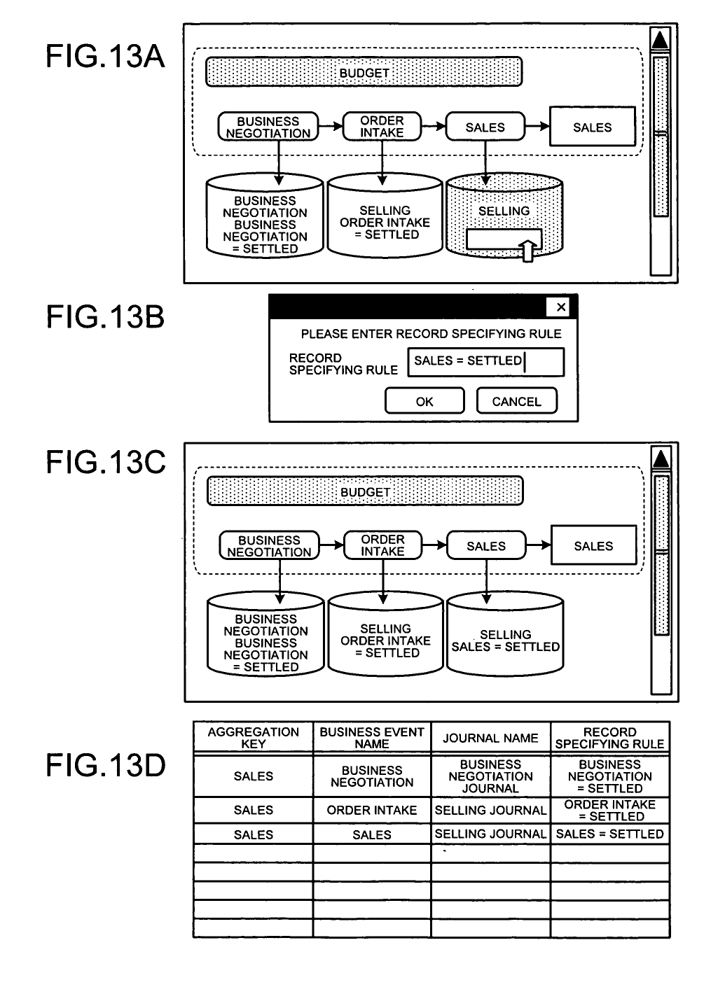

Therefore, only points to which particular attention should be paid are explained. For example, as can be seen from FIG. 13A, both of the detailed data having the business event name “order intake” and the detailed data having the business event name “sales” are accumulated in the same journal identified by the journal name “selling journal”. Therefore, the detailed data associating apparatus 10 according to the present invention, input the record specifying rule specifying the record in the journal to appropriately associate the detailed data. Note that, when each piece of the detailed data is accumulated in the different journal identified by the different journal name, the detailed data associating apparatus 10 may specify alternative form of the record specifying rule such as those specifying not to associate the unsettled detailed data but to associate only the “settled” detailed data.

Other points that should be paid attention are explained. As can be seen in the sections (D) in FIGS. 5D to 16D, the associations are sequentially stored in the association storage unit 22 as shown.

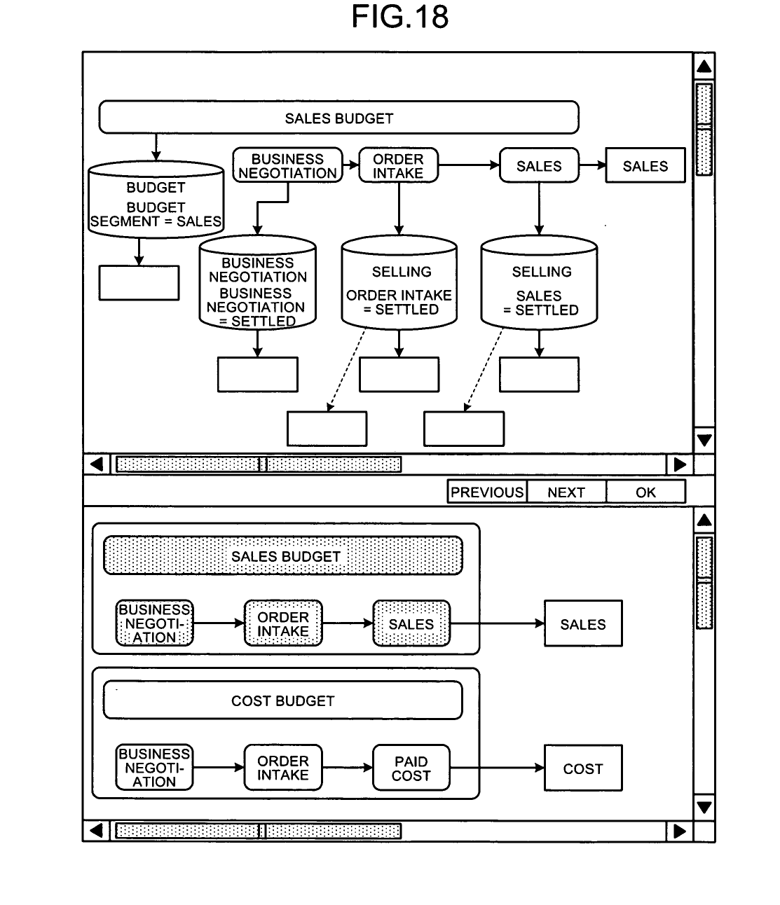

Note that, FIG. 17 is a view of an exemplary screen image output on the display by the detailed data associating apparatus 10 such that the associations between the business event names and the segments in relation to the aggregation (the aggregation keys “sales” and “cost”) keys are simultaneously output. In FIG. 18, the detailed data associating apparatus 10 divides the screen image to be output to the display into two portions. In a bottom window, the detailed data associating apparatus 10 simultaneously outputs the associations between the business event names and the segments in relation to the aggregation keys. On a top window, in relation to the selected aggregation key “sales” (the icons related to the aggregation key “sales” are turned to have half-tone dot meshing to show that those icons are selected on the bottom window), the associations between the business event names and the segments, the associations between the journal names and the business event names, and the association between the record specifying rules and the journal names are output. On the top window in FIG. 18, icons of each journal, squares connected by solid lines, and squares connected by broken lines are output. This illustrates, for example, the detailed data associating apparatus 10 associates the solid line connected squares with the settled detailed data in the segment and associates the broken line connected squares with the detailed data having a content that cancels the detailed data predicted in a preceding segment (detailed data for cancellation).

The shared output unit 34 outputs the business event name shared by the aggregation keys so as to explicitly show that the business event name is shared between the aggregation keys. In particular, the shared output unit 34 outputs so as to explicitly show, when the association between the business event name and the segment created by the business event name creating unit 31, the association between the journal name and the business event name created by the journal name creating unit 32, and the association between record specifying rule and the journal name created by the rule creating unit 33 are output simultaneously to the output unit 12 in relation to the aggregation keys, that the business event name is shared between the aggregation keys.

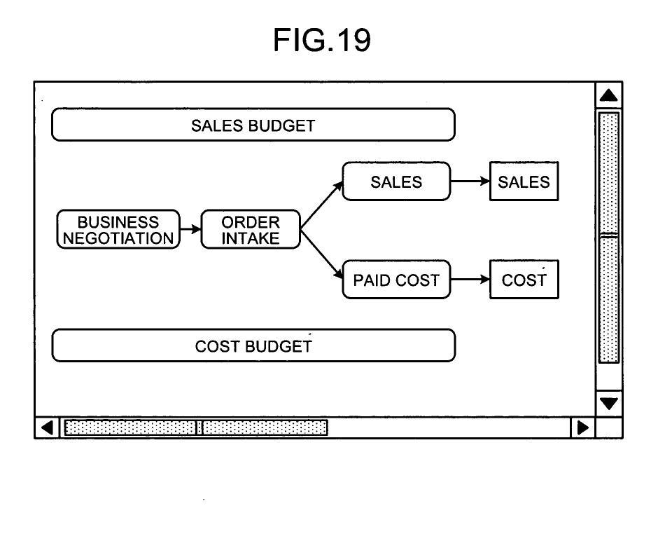

For example, the shared output unit 34 outputs a screen image to the display as depicted in FIG. 19. To explain FIG. 19, each of the business event names “business negotiation” and “order intake” shared by the aggregation keys (the aggregation keys “sales” and “cost”) is output to each icon, while the business event names “sales” and “paid cost” are respectively branched from the each icon. Therefore explicitly showing that the business event names “business negotiation” and “order intake” are shared by the aggregation keys. Note that, the screen image depicted in FIG. 19 is only an example and any particular output screen image may be used such as to output so as to explicitly show the business event name is shared by the aggregation keys by using an alternative output screen image. FIG. 19 is simply a figure intended to explain sharing of the business event and not necessarily means that the business event names “business negotiation” and “order intake” are shared by the aggregation keys “sales” and “cost”.

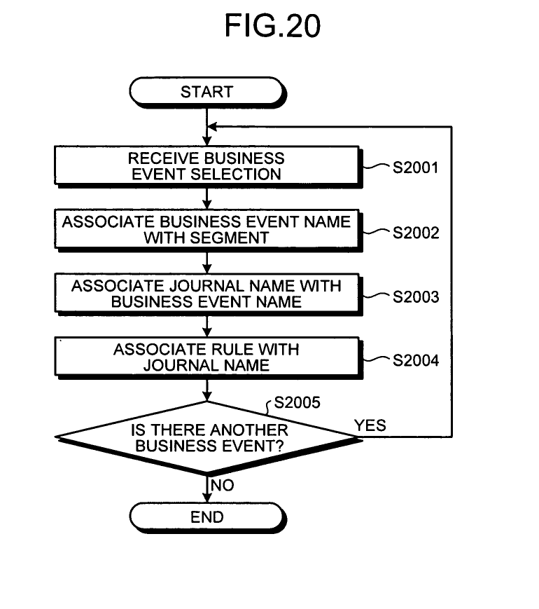

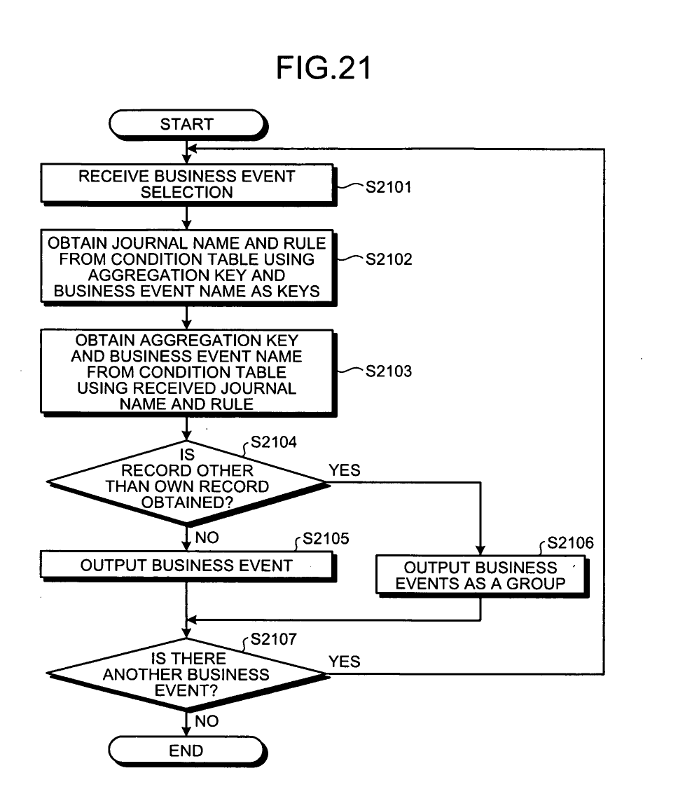

Referring to FIGS. 20 and 21, an example of processing of the detailed data associating apparatus according to the first embodiment is explained. FIG. 20 is a flowchart of the processing procedure of the detailed data associating apparatus according to the first embodiment. FIG. 21 is a flowchart of a processing procedure of the shared output unit.

Referring to FIG. 20, a detailed data associating process (a business event name creating process, a journal name creating process, and a rule creating process) performed by the detailed data associating apparatus 10 is explained. In the flowchart depicted in FIG. 20, an aggregation key of the detailed data subjected to the detailed data associating process is assumed to be specified in advance by a user of the detailed data associating apparatus 10.

In other words, according to the first embodiment, the detailed data associating apparatus 10 performs the detailed data associating process on each aggregation key basis. Therefore, it is assumed be performed, for example, one aggregation key is selected in advance, once the detailed data associating process applied to this aggregation key is completed according to the flowchart depicted in FIG. 20, another aggregation key next in line is subsequently specified, again, the detailed data associating process applied to this aggregation key is completed according to the flowchart depicted in FIG. 20. Note that, according to the first embodiment, while an example that the detailed data associating apparatus 10 associates the detailed data following the procedure described above is explained, the present invention is not limited so and any procedure can be applied such as storing all aggregation keys in the storage unit in advance to go through the process without specifying the aggregation key.

The detailed data associating apparatus 10 receives a business event selected by a user of the detailed data associating apparatus 10 (Step S2001). For example, the detailed data associating apparatus 10 receives the business event “plan” selected by a user by clicking, or in an alternative manner, the “plan” icon.

The detailed data associating apparatus 10 outputs a business pattern stored in the business pattern storage unit 21 by the business event name creating unit 31, so as to explicitly show the association between the segments, receives a business event name input identifying the segments belonging to each aggregation key via the input unit 11, and associates the input business event name with a segment (Step S2002). For example, the detailed data associating apparatus 10 receives the business event name “business negotiation” input via a keyboard and associates the input business event name “business negotiation” with the segment “plan” by the business event name creating unit 31.

The detailed data associating apparatus 10 outputs the business event name input in the business event name creating unit 31 to the output unit 12 by the journal name creating unit 32, receives a journal name input identifying the journal that the journal accumulating therein the detailed data identified by the business event name at the input unit 11, and associates the input journal name with the business event name (Step S2003). For example, the detailed data associating apparatus 10, at the journal name creating unit 32, receives the journal name “business negotiation journal” input via a keyboard and associates the input journal name “business negotiation journal” with the business event name “business negotiation”.

The detailed data associating apparatus 10, at the rule creating unit 33, outputs the journal name received in the journal name creating unit 32 to the output unit 12, receives, in the input unit 11, a record specifying rule input that specifies which record in the journal identified by the journal name the detailed data identified by the business event name input in the business event name creating unit 31 is, and associates the input record specifying rule and the journal name (Step S2004). For example, the detailed data associating apparatus 10, at the rule creating unit 33, receives the record specifying rule “business negotiation=settled” input via a keyboard and associates the input record specifying rule “business negotiation=settled” with the journal name “business negotiation journal”.

Then, the detailed data associating apparatus 10 determines if another business event is present (Step S2005). If so (YES at Step S2005), the detailed data associating apparatus 10 loops back to the step to receive the business event selected by a user of the detailed data associating apparatus 10. If not (NO at Step S2005), the detailed data associating apparatus 10 ends the process and starts the detailed data associating process with respect to another aggregation key next in line.

According to the first embodiment, a procedure is explained such that the detailed data associating apparatus 10 associates the business event name with the segment, then associates the journal name with the business event name, subsequently associates the record specifying rule with the journal name with respect to one business event, and then the procedure is applied to another business event. However, the present invention is not limited so. For example, any sequence can be equally applied to the present invention such as a sequence that the detailed data associating apparatus 10 associates the business event name with the segment, then associates the journal name with the business event name for all business patterns, subsequently associates the record specifying rule with the journal name for all business patterns.

Referring to FIG. 21, a shared output process performed by the shared output unit 34 in the detailed data associating apparatus 10 is explained. Note that, the “condition table” in the flowchart depicted in FIG. 21 refers to the association storage unit 22 in the detailed data associating apparatus 10.

The shared output unit 34 receives a business event selected by a user of the detailed data associating apparatus 10 (Step S2101). For example, the shared output unit 34 receives the business event “business negotiation” selected and being input by a user via a keyboard or in alternative manner.

The shared output unit 34 obtains a journal name and a record specifying rule from the condition table using a aggregation key and a business event name as keys (Step S2102). For example, the shared output unit 34 obtains the journal name “business negotiation journal” and the record specifying rule “business negotiation=settled” from the condition table as depicted in FIG. 4 using the aggregation key “sales” and the business event name “business negotiation” as keys.

The shared output unit 34 obtains an aggregation key and a business event name from the condition table using the obtained journal name and the record specific rule as keys (Step S2103). For example, the shared output unit 34 obtains the aggregation key “cost” and the business event name “business negotiation” from the condition table as depicted in FIG. 4 using the journal name “business negotiation journal” and the record specifying rule “business negotiation=settled” as keys.

Subsequently, the shared output unit 34 determines whether a record other than own record is obtained at Step S2103 (Step S2104). If not (NO at Step S2104), the shared output unit 34 outputs the business event (S2105). On the other hand, if so (YES at Step S2104), the shared output unit 34 outputs business events as a group (Step S2106). For example, the shared output unit 34 outputs the business events as a group so as to explicitly show that the business event name “business negotiation” is shared by the aggregation keys “sales” and “cost”.

Then, the shared output unit 34 determines whether another business event is present (Step S2107). If so (YES at Step S2107), the shared output unit 34 loops back to the step to receive the business event selected by a user of the detailed data associating apparatus 10. On the other hand, if not (NO at Step S2107), the shared output unit 34 ends the process.

As described above, according to the first embodiment, a detailed data associating program causes a computer to perform the method for associating the detailed data to aggregate the detailed data by using the aggregation key when the detailed data generated in relation to the business is accumulated in the predetermined journal in a format that can identify the aggregation key used to aggregate the detailed data and the segment used to manage the detailed data in the business, the method including storing the association between the segments as the business pattern corresponding to the primary aggregation key, which is a broader concept of the aggregation key; outputting the stored business pattern to the predetermined output unit so as to explicitly show the association between the segments, receiving the business event name input in the predetermined input unit that identifies the segments belonging to each aggregation key, and associating the input business event name with the segment; outputting the input business event name to the predetermined output unit, receiving the journal name input, identifying the journal accumulating therein the detailed data identified by the business event name in the predetermined input unit, and associating the input journal name with the business event name; and outputting the input journal name to the predetermined output unit, receiving in the predetermined input unit the record specifying rule input specifying which record in the journal identified by the journal name the detailed data identified by the input business event name is, and associating the input record specifying rule with the journal name, enabling the system intended to aggregate the “detailed data” to be readily developed. To explain concretely, for example, a user or the like of the system is only required to understand the business pattern (association between the segments used to manage the detailed data in business) as knowledge in the course of his/her work related to the detailed data aggregation and only to input the associations between the business pattern and the business event name, the journal name, and the record specifying rule while viewing the business pattern output on the output unit such as a display, the system intended to aggregate the detailed data can be developed.

According to the first embodiment, when a business pattern is output to the predetermined output unit, not only the association between the segments is explicitly shown, but also the association with the primary aggregation key or the aggregation key is also explicitly shown. Therefore, in addition to the above effect, it is possible to make the developer of the system intended to aggregate the detailed data intuitively understand the association between a business pattern and an aggregation key (primary aggregation key). Moreover, in analyzing a business flow, it is also possible to make a user intuitively understand the association between a business pattern and an aggregation key (primary aggregation key).

According to the first embodiment, when any one, two, or all of the association created between a business event name and a segment, the association created between a journal name and a business event name, the association created between a record specifying rule and a journal name is/are output to the predetermined output unit simultaneously in relation to the aggregation keys, a business event name shared by aggregation keys is explicitly shown as such. Therefore, in addition to the above effect, it is possible to make the developer of the system intended to aggregate the detailed data intuitively understand the business event shared by the aggregation keys. Moreover, in analyzing a business flow, it is also possible to make a user intuitively understand the overview of which each business event is originated from.

The detailed data associating apparatus according to the first embodiment has been explained above, the present invention may be implemented in various different embodiments other than the embodiment described above. Therefore, a detailed data associating apparatus according to a second embodiment is explained below in various different embodiments.

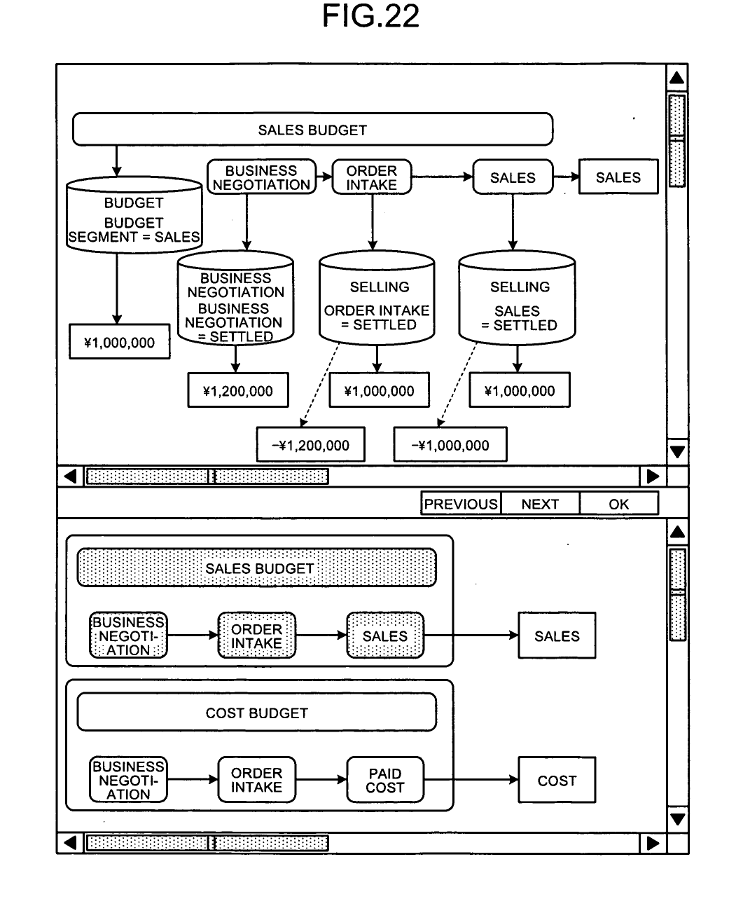

The detailed data associating apparatus according to the first embodiment is not explained as performing a process to associate the created association with the detailed data. However, the present invention is not limited so and can be equally applied to the process to associate the created association with the detailed data performed by the detailed data associating apparatus. In particular, the detailed data associating apparatus is to include a detailed data associating unit that associates the detailed data according to the association between a business event name and a segment created by the business event name creating unit 31, the association between a journal name and a business event name created by the journal name creating unit 32, the association between a record specifying rule and a journal name created by the rule creating unit 33. Further, the detailed data associating apparatus can also output and explicitly show the association between the detailed data associated by the detailed data associating unit and a business event name, a journal name, a record specifying rule, or the like. For example, the detailed data associating apparatus according to the second embodiment can, as depicted in FIG. 22, output the screen image that explicitly shows the association between the detailed data to the display or the like.

In this case, according to the association created between a business event name and a segment, the association created between a journal name and a business event name, the association between created a record specifying rule and a journal name, the detailed data accumulated in the journal is associated and output to the predetermined output unit such that the associated detailed data and any one, two, or all of a business event name, a journal name, a record specifying rule is/are explicitly shown. Therefore, in using the developed system, similar to the output when developing the system, a user is only required to understand the business pattern as knowledge in the course of his/her work related to the detailed data aggregation to be able to intuitively understand the aggregation result of the detailed data. For example, because a conventional profit and loss analysis only analyzes based on a result of summed up numbers, the conventional profit and loss analysis can only analyze the figures but not the business flow. According to the second embodiment, what kind of business leads to the result of summed up numbers can be explicitly shown, enabling to also analyze the business flow.

Further, the detailed data associating apparatus according to the first embodiment including the shared output unit 34 is explained as an example. The shared output unit 34 outputs and explicitly shows that the business event name is shared by the aggregation keys. However, the present invention is not limited so and can be equally applied to the detailed data associating apparatus that may not include the shared output unit 34 and may not output the output screen image exemplary depicted in FIG. 19.

Some or all of the processes described in the present embodiment can be manually performed even though the process(es) is(are) described to be automatically performed. Some or all of the processes described above (such as the process to receive the selected business event in the shared output unit 34) can be automatically performed using any known methods even thought the process(es) is(are) described to be manually performed (for example, instead of receiving the selected business event, the shared output unit 34 processes and outputs a business event automatically or in alternative manner). In addition, information including process procedures, controlling procedures, specific names, and various data and parameters described in the description or depicted in the drawings can be arbitrarily modified unless otherwise specified.

Various components of the apparatus depicted in the drawings (such as FIG. 2) are conceptually shown in terms of their functions, therefore, they are not required to be physically configured as shown. Therefore, distribution and integration of the apparatus are not limited to those shown in the drawings, and some or all of the components can be arbitrarily distributed or integrated depending on various loads or use (for example, the association storage units are provided for each of the business event name creating unit 31, the journal name creating unit 32, the rule creating unit 33). Further, some or all of processing functions performed by the components of the apparatus may be embodied as a central processing unit (CPU) and a computer program analyzed and performed by the CPU, or a hardware using wired logic.

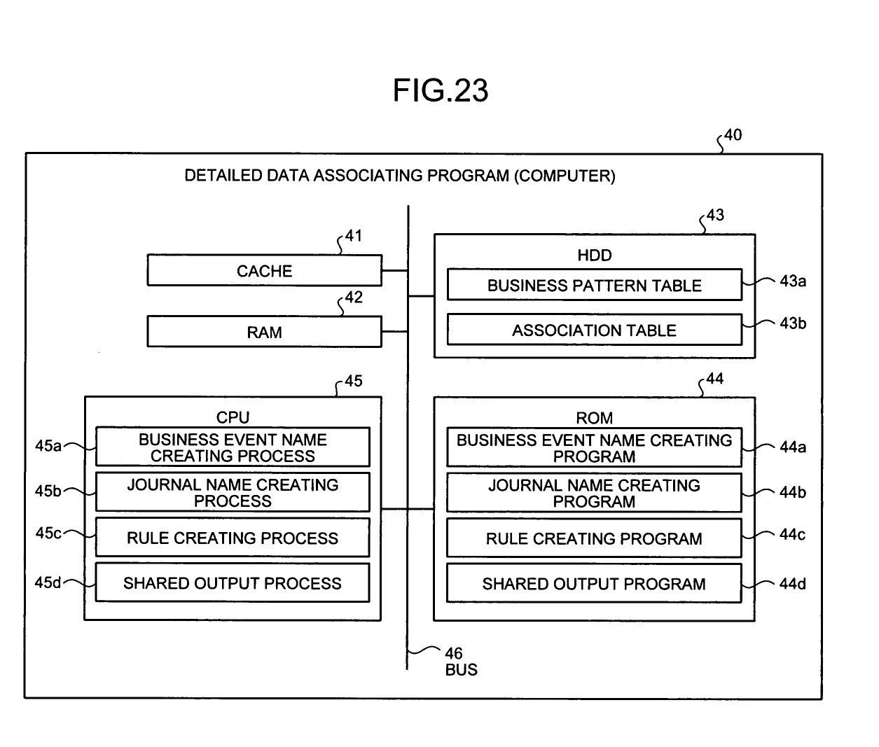

As depicted in FIG. 23, the detailed data associating program (a computer) 40 includes a cache 41, a random access memory (RAM) 42, a hard disk drive (HDD) 43, a read only memory (ROM) 44, and a CPU 45, each of which is connected via a bus 46. The ROM 44 stores therein in advance the detailed data associating program that functions similarly to the first embodiment described above, that is, as depicted in FIG. 23, a business event name creating program 44a, a journal name creating program 44b, a rule creating program 44c, and a shared output program 44d.

The CPU 45 retrieves and executes these computer programs 44a to 44d to generate, as depicted in FIG. 23, a business event name creating process 45a, a journal name creating process 45b, a rule creating process 45c, and a shared output process 45d. Note that, the processes 45a to 45d corresponds to the business event name creating unit 31, the journal name creating unit 32, the rule creating unit 33, and the shared output unit 34, respectively, depicted in FIG. 2.

The HDD 43 is provided with a business pattern table 43a and an association table 43b as depicted in FIG. 23. Note that, the tables 43a and 43b correspond to the business pattern storage unit 21 and the association storage unit 22, respectively, depicted in FIG. 2.

The computer programs 44a to 44d are not necessarily stored in the ROM 44. For example, the computer 40 may retrieve and execute each of the computer programs 44a to 44d stored in a “portable physical medium” that can be inserted to the computer 40, such as a flexible disk (FD), a CD-ROM, a magneto-optical (MO) disk, a digital versatile disk (DVD), the magneto-optical disk, or an integrated circuit (IC) card, in a “fixed physical medium” that is located internal or external to the computer 40 such as an HDD, or in “other computer (or a server)” that can be connected to the computer 40 via a public line, an Internet, a local area network (LAN), a wide area network (WAN), or the like.

According to the embodiments, it is possible to readily develop the system intended to aggregate the detailed data. More specifically, for example, a user of the system or the like is only required to understand the business pattern (association between the segments used to manage the detailed data in the business) as knowledge in the course of his/her work related to the detailed data aggregation and to input the associations between the business pattern and the business event name, the journal name, and the rule while viewing the business pattern output on the output unit such as a display, a system intended to aggregate the detailed data can be developed.

Further, according to the embodiments, in addition to the above effect, the developer of the system intended to aggregate the detailed data may intuitively understand the association between the business pattern and the aggregation key (primary aggregation key). Moreover, in analyzing a business flow, a user may intuitively understand the association between the business pattern and the aggregation key (primary aggregation key).

According to the embodiments, in addition to the above effect, the developer of the system intended to aggregate the detailed data may intuitively understand the business event shared by the aggregation keys. Moreover, in analyzing a business flow, a user may intuitively understand overview showing the detailed data from which each business event is originated.

According to the embodiments, in addition to the above effect, in using the developed system, as with the output when developing the system, a user is only required to understand the business pattern as knowledge in the course of his/her work related to the detailed data aggregation to be able to intuitively understand the aggregation result of the detailed data. For example, because a conventional profit and loss analysis only analyzes based on a result of summed up numbers, the conventional profit and loss analysis can only analyze the figures but not the business flow. According to the present invention, what kind of business leads to the result of summed up numbers can be explicitly shown, enabling to also analyze the business flow.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium that stores a detailed data associating program that causes a computer to execute a method for creating an association between pieces of detailed data to aggregate the detailed data by using an aggregation key when the detailed data generated in relation to a business is accumulated in a predetermined journal in a format that identifies the aggregation key used to aggregate the detailed data and segments used to manage the detailed data in the course of business, the detailed data associating program causing the computer to execute:
storing the association between the segments as a business pattern corresponding to a primary aggregation key that is a broader concept of the aggregation key;
outputting the business pattern stored at the storing, to a predetermined output unit so as to explicitly show the association between the segments, receiving in a predetermined input unit a business event name input that identifies the segments belonging to each aggregation key, and creating the association between the received business event name and each segment;
outputting the business event name received at the receiving to a predetermined output unit, receiving a journal name input identifying a journal that accumulates therein the detailed data identified by the business event name in a predetermined input unit, and associating the received journal name with the business event name; and
outputting the journal name received at the receiving to a predetermined output unit, receiving a rule in a predetermined input unit, the rule specifying which record in the journal identified by the journal name the detailed data identified by the business event name received at the receiving is, and associating the received rule with the journal name.

2. The computer-readable recording medium according to claim 1, wherein the detailed data associating program further causes the computer to execute outputting to explicitly show not only the association between the segments, but also the association with the primary aggregation key or the aggregation key when outputting the business pattern to the predetermined output unit.

3. The computer-readable recording medium according to claim 1, wherein the detailed data associating program further causes the computer to execute outputting a business event name shared by a plurality of such aggregation keys to explicitly show that the business event name is shared by the aggregation keys, when outputting any one, two, or all of the association between the business event name and each segment created at the associating, the association between the journal name and the business event name created at the associating, and the association between the rule and the journal name created at the associating simultaneously to a predetermined output unit in relation to the aggregation keys.

4. The computer-readable recording medium according to claim 1, wherein the detailed data associating program, further causes the computer to execute:
associating each piece of the detailed data accumulated in the journal according to the association between the business event name and each segment created at the associating, the association between the journal name and the business event name created at the associating, and the association between the rule and the journal name created at the associating; and
outputting so as to explicitly show the association between pieces of the detailed data associated at the associating and any one, two, or all of the business event name, the journal name, and the rule to a predetermined output unit.

5. A detailed data associating apparatus for creating an association between pieces of detailed data to aggregate the detailed data by using an aggregation key when the detailed data generated in relation to a business is accumulated in a predetermined journal in a format that identifies the aggregation key used to aggregate the detailed data and segments used to manage the detailed data in the course of business, the detailed data associating apparatus comprising:
a business pattern storing unit that stores the association between the segments as a business pattern corresponding to a primary aggregation key that is a broader concept of the aggregation key;
a business event name creating unit that outputs the business pattern stored in the business pattern storing unit, to a predetermined output unit so as to explicitly show the association between the segments, receives in a predetermined input unit a business event name input that identifies the segments belonging to each aggregation key, and creates the association between the received business event name and each segment;
a journal name creating unit that outputs the business event name received by the business event name creating unit to a predetermined output unit, receives a journal name input identifying a journal that accumulates therein the detailed data identified by the business event name in a predetermined input unit, and associates the received journal name with the business event name; and
a rule creating unit that outputs the journal name received by the journal name creating unit to a predetermined output unit, receives a rule in a predetermined input unit, the rule specifying which record in the journal identified by the journal name the detailed data identified by the business event name received by the business event name creating unit is, and associates the received rule with the journal name.

6. The detailed data associating apparatus according to claim 5, wherein the business event name creating unit outputs to explicitly show not only the association between the segments, but also the association with the primary aggregation key or the aggregation key when outputting the business pattern to the predetermined output unit.

7. The detailed data associating apparatus according to claim 5, further comprising a shared output unit that outputs a business event name shared by a plurality of such aggregation keys to explicitly show that the business event name is shared by the aggregation keys, when outputting any one, two, or all of the association between the business event name and each segment created by the business event name creating unit, the association between the journal name and the business event name created by the journal name creating unit, and the association between the rule and the journal name created by the rule creating unit simultaneously to a predetermined output unit in relation to the aggregation keys.

8. The detailed data associating apparatus according to claim 5, further comprising:
a detailed data associating unit that associates each piece of the detailed data accumulated in the journal according to the association between the business event name and each segment created by the business event name creating unit, the association between the journal name and the business event name created by the journal name creating unit, and the association between the rule and the journal name created by the rule creating unit; and
a detailed data output unit that outputs so as to explicitly show the association between pieces of the detailed data associated by the detailed data associating unit and any one, two, or all of the business event name, the journal name, and the rule to a predetermined output unit.

9. A detailed data associating method for creating an association between pieces of detailed data to aggregate the detailed data by using an aggregation key when the detailed data generated in relation to a business is accumulated in a predetermined journal in a format that identifies the aggregation key used to aggregate the detailed data and segments used to manage the detailed data in the course of business, the detailed data associating method comprising:
storing the association between the segments as a business pattern corresponding to a primary aggregation key that is a broader concept of the aggregation key;
outputting the business pattern stored at the storing, to a predetermined output unit so as to explicitly show the association between the segments, receiving in a predetermined input unit a business event name input that identifies the segments belonging to each aggregation key, and creating the association between the received business event name and each segment;
outputting the business event name received at the receiving to a predetermined output unit, receiving a journal name input identifying a journal that accumulates therein the detailed data identified by the business event name in a predetermined input unit, and associating the received journal name with the business event name; and
outputting the journal name received at the receiving to a predetermined output unit, receiving a rule in a predetermined input unit, the rule specifying which record in the journal identified by the journal name the detailed data identified by the business event name received at the receiving is, and associating the received rule with the journal name.

10. The detailed data associating method according to claim 9, wherein further includes outputting to explicitly show not only the association between the segments, but also the association with the primary aggregation key or the aggregation key when outputting the business pattern to the predetermined output unit.

11. The detailed data associating method according to claim 9, further comprising outputting a business event name shared by a plurality of such aggregation keys to explicitly show that the business event name is shared by the aggregation keys, when outputting any one, two, or all of the association between the business event name and each segment created at the associating, the association between the journal name and the business event name created at the associating, and the association between the rule and the journal name created at the associating simultaneously to a predetermined output unit in relation to the aggregation keys.

12. The detailed data associating method according to claim 9, further comprising:
associating each piece of the detailed data accumulated in the journal according to the association between the business event name and each segment created at the associating, the association between the journal name and the business event name created at the associating, and the association between the rule and the journal name created at the associating; and
outputting so as to explicitly show the association between pieces of the detailed data associated at the associating and any one, two, or all of the business event name, the journal name, and the rule to a predetermined output unit.
